(19) United States
(12) Patent Application Publication
(10) Pub. No.: US 2024/0273888 A1
(43) Pub. Date: Aug. 15, 2024

(54) POST-PROCESSING APPARATUS FOR A MULTI-TASK DEEP LEARNING MODEL AND A METHOD THEREOF

(71) Applicants: HYUNDAI MOTOR COMPANY, Seoul (KR); KIA CORPORATION, Seoul (KR)

(72) Inventors: Min Young Yoon, Seoul (KR); Jin Sol Kim, Hwaseong-si (KR)

(73) Assignees: HYUNDAI MOTOR COMPANY, Seoul (KR); KIA CORPORATION, Seoul (KR)

(21) Appl. No.: 18/223,145

(22) Filed: Jul. 18, 2023

(30) Foreign Application Priority Data
Feb. 10, 2023 (KR) 10-2023-0018309

(51) Int. Cl. G06V 10/82; G06T 7/00; G06V 10/25; G06V 10/764

(52) U.S. Cl. CPC G06V 10/82; G06T 7/0002; G06V 10/25; G06V 10/764; G06V 2201/07

(57) ABSTRACT

A post-processing apparatus includes storage that stores a multi-task learning model. The post-processing apparatus also includes a controller that may generate a first entropy image from an output image of a first deep neural network (DNN) within the multi-task learning model. The controller may also generate a second entropy image from an output image of a second DNN in the multi-task learning model. The controller may post-process the output image of the first DNN based on the first entropy image and the second entropy image.

### CROSS-REFERENCE TO RELATED APPLICATION

This application claims priority to and the benefit of Korean Patent Application No. 10-2023-0018309, filed on Feb. 10, 2023, the entire contents of which are incorporated herein by reference.

### TECHNICAL FIELD

The present disclosure relates to a technique for post-processing an image output from a multi-task learning model.

### BACKGROUND

In the field of artificial intelligence, an artificial neural network (ANN) is an algorithm that allows a machine to learn made by simulating a human neural structure. Recently, ANNs have been used in image recognition, speech recognition, natural language processing, and the like, and have shown excellent results. An artificial neural network includes an input layer that receives an input, a hidden layer that performs learning, and an output layer that returns the result of an operation. An artificial neural network that includes a plurality of hidden layers is called a deep neural network (DNN). DNN is a type of ANN. A deep neural network may comprise a convolutional neural network (CNN) or a recurrent neural network (RNN) depending on the structure, problem to be solved, purpose, and the like.

An artificial neural network allows a computer to learn by itself based on data. When solving a problem using an artificial neural network, it is desired to prepare a suitable artificial neural network model and data to be analyzed. An artificial neural network model for solving a problem is trained based on data. Before training the model, it is desired to properly process the data. This is because the input data and output data required by the artificial neural network model are standardized. Therefore, a process of preprocessing obtained raw data to suit the requested input data is required. After preprocessing, the processed data needs to be divided into two types. In particular, the data should be divided into a training dataset and a validation dataset. The training dataset is used to train the model, and the validation dataset is used to verify the performance of the model.

There are various reasons for validating an artificial neural network model. For example, an artificial neural network developer may tune the model by modifying hyper parameters of a model based on the verification result of the model. As another example, model verification may be performed to select a suitable model from various models. Several reasons for why the model verification may be desired are explained in more detail as follows.

First, model verification may be used to predict accuracy. The purpose of artificial neural networks is to achieve good performance on out-of-sample data not used for training. Therefore, after creating the model, it is desired to check how well the model will perform on out-of-sample data. Because the model cannot be verified using the training dataset, the accuracy of the model should be measured using the validation dataset separate from the training dataset.

Secondly, model verification may be used to increase the performance of the model by tuning the model. For example, it is possible to prevent overfitting. Overfitting occurs when the model is over-trained on the training dataset. When the training accuracy is high, but the validation accuracy is low, the occurrence of overfitting may be suspected. In addition, overfitting may be understood in more detail through training loss and validation loss. When overfitting occurs, it is desired to prevent overfitting to increase the validation accuracy. It is possible to prevent overfitting by using a scheme such as regularization or dropout.

A multi-task learning model used for image recognition in an autonomous vehicle may simultaneously learn a plurality of tasks. For example, the multi-task learning model may recognize an area where contamination of a camera lens has occurred in an input image, recognize roads, vehicles, and pedestrians in the input image, and recognize the depth of an object in the input image.

Such a multi-task learning model may misrecognize a contaminated area of a camera lens in an input image, misrecognize a road, a vehicle or a pedestrian in the input image, or misrecognize the depth of an object in the input image. The misrecognition phenomenon frequently occurs when the illumination of the input image is low or when the image of a driving road is dark, for example, in a case where the input image is captured at night.

The matters described in this background section are intended to promote an understanding of the background of the disclosure and may include matters that are not already known to those having ordinary skill in the art.

### SUMMARY

The present disclosure has been made to solve the above-mentioned problems occurring in the prior art while advantages achieved by the prior art are maintained intact.

One aspect of the present disclosure provides a post-processing apparatus for a multi-task learning model, and a method thereof, that can generate a first entropy image from an output image of a first deep neural network (DNN) in the multi-task learning model, generate a second entropy image from an output image of a second DNN, and post-process the output image of the first DNN or the second DNN based on the first entropy image and the second entropy image, thereby improving the performance of the multi-task learning model.

Another aspect of the present disclosure provides a post-processing apparatus for a multi-task learning model, and a method thereof, that can post-process the output image of the first DNN based on the entropy of each pixel in the first entropy image and the entropy of each pixel in the second entropy image, thereby improving the performance of the first DNN.

Another aspect of the present disclosure provides a post-processing apparatus for a multi-task learning model, and a method thereof, that can post-process the output image of the second DNN based on the entropy of each pixel in the first entropy image and the entropy of each pixel in the second entropy image, thereby improving the performance of the second DNN.

Still another aspect of the present disclosure provides a post-processing apparatus for a multi-task learning model, and a method thereof, that can generate a first entropy image from an output image of a soiling detection DNN in the multi-task learning model, generate a second entropy image from an output image of a space detection DNN, and post-process the output image of the soiling detection DNN based on the first entropy image and the second entropy image, thereby improving the performance of the multi-task learning model.

Still another aspect of the present disclosure provides a post-processing apparatus for a multi-task learning model, and a method thereof, that can remove a misrecognized area from the output image of the soiling detection DNN based on the entropy of each pixel in the first entropy image and the entropy of each pixel in the second entropy image, thereby improving the performance of the soiling detection DNN.

Still another aspect of the present disclosure provides a post-processing apparatus for a multi-task learning model, and a method thereof, that can remove a misrecognized area from the output image of the space detection DNN based on the entropy of each pixel in the first entropy image and the entropy of each pixel in the second entropy image, thereby improving the performance of the space detection DNN.

Still another aspect of the present disclosure provides a post-processing apparatus for a multi-task learning model, and a method thereof, that can prevent misrecognition of the area where contamination of a camera lens has occurred in an input image, misrecognition of roads, vehicles, pedestrians, and the like in the input image, or misrecognition of the depth of an object in the input image even when the illumination of the input image is low or the image of a driving road is dark.

The technical problems to be solved by the present disclosure are not limited to the aforementioned problems, and other technical problems not mentioned herein may be clearly understood from the following description by those having ordinary skill in the art to which the present disclosure pertains. Also, it may be easily understood that the objects and advantages of the present disclosure may be realized by the units and combinations thereof recited in the claims.

According to an embodiment of the present disclosure, a post-processing apparatus for a multi-task learning model includes storage that stores the multi-task learning model. The post-processing apparatus also includes a controller configured to generate a first entropy image from an output image of a first deep neural network (DNN) within the multi-task learning model. The controller is also configured to generate a second entropy image from an output image of a second DNN in the multi-task learning model. The controller is configured to post-process the output image of the first DNN based on the first entropy image and the second entropy image.

In an aspect, the controller may be configured to post-process the output image of the first DNN based on entropy of each pixel in the first entropy image and entropy of each pixel in the second entropy image.

In an aspect, the first DNN may include a soiling detection DNN configured to recognize an area in which a camera lens is contaminated in an input image.

In an aspect, the second DNN may include a space detection DNN configured to classify pixels in the input image by category and detect an object corresponding to each category.

In an aspect, the controller may be configured to generate the first entropy image from the output image of the soiling detection DNN. The controller may also be configured to generate the second entropy image from the output image of the space detection DNN. The controller may be configured to post-process the output image of the soiling detection DNN based on the first entropy image and the second entropy image.

In an aspect, the controller may be configured to remove a misrecognized area from the output image of the soiling detection DNN based on the entropy of each pixel in the first entropy image and the entropy of each pixel in the second entropy image.

In an aspect, the controller may be configured to determine a first pixel as a contaminated area in the output image of the soiling detection DNN when entropy of the first pixel in the first entropy image does not exceed a threshold and entropy of the first pixel in the second entropy image exceeds the threshold.

In an aspect, the controller may be configured to determine a first pixel as a normal area in the output image of the soiling detection DNN and remove the first pixel from a misrecognized area in the output image of the soiling detection DNN when entropy of the first pixel in the first entropy image exceeds a threshold and entropy of a first pixel in the second entropy image does not exceed the threshold.

According to another embodiment of the present disclosure, a post-processing method for a multi-task learning model includes generating, by a controller, a first entropy image from an output image of a first deep neural network (DNN) within the multi-task learning model. The post-processing method also includes generating, by the controller, a second entropy image from an output image of a second DNN in the multi-task learning model. The post-processing method additionally includes post-processing, by the controller, the output image of the first DNN based on the first entropy image and the second entropy image.

In an aspect, post-processing the output image of the first DNN may include post-processing the output image of the first DNN based on entropy of each pixel in the first entropy image and entropy of each pixel in the second entropy image.

According to still another embodiment of the present disclosure, a post-processing method for a multi-task learning model includes generating, by a controller, a first entropy image from an output image of a soiling detection DNN. The post-processing method also includes generating, by the controller, a second entropy image from an output image of a space detection DNN, and post-processing, by the controller, the output image of the soiling detection DNN based on the first entropy image and the second entropy image.

In an aspect, post-processing the output image of the soiling detection DNN may include removing a misrecognized area from the output image of the soiling detection DNN based on entropy of each pixel in the first entropy image and entropy of each pixel in the second entropy image.

In an aspect, removing the misrecognized area may include determining a first pixel as a contaminated area in the output image of the soiling detection DNN when entropy of the first pixel in the first entropy image does not exceed a threshold and entropy of the first pixel in the second entropy image exceeds the threshold.

In an aspect, removing the misrecognized area may include determining a first pixel as a normal area in the output image of the soiling detection DNN when entropy of the first pixel in the first entropy image exceeds a threshold and entropy of a first pixel in the second entropy image does not exceed the threshold, and removing the first pixel from a misrecognized area in the output image of the soiling detection DNN.

### BRIEF DESCRIPTION OF THE DRAWINGS

The above and other objects, features and advantages of the present disclosure should become more apparent from the following detailed description taken in conjunction with the accompanying drawings, in which:

FIG. 1 is a diagram illustrating a multi-task learning model, according to an embodiment of the present disclosure;

FIG. 2 is a diagram illustrating a post-processing apparatus of a multi-task learning model, according to an embodiment of the present disclosure;

FIG. 3A is a diagram illustrating a camera image input to a shared network of a multi-task learning model, according to an embodiment of the present disclosure;

FIG. 3B is a diagram illustrating an output image of a space detection DNN in a multi-task learning model, according to an embodiment of the present disclosure;

FIG. 3C is a diagram illustrating entropy image generated by a controller included in a post-processing apparatus of a multi-task learning model based on an output image of a space detection DNN, according to an embodiment of the present disclosure;

FIG. 3D is a diagram illustrating an output image of a soiling detection DNN in a multi-task learning model, according to an embodiment of the present disclosure;

FIGS. 4A-C are diagrams illustrating performance of a post-processing apparatus of a multi-task learning model, according to an embodiment of the present disclosure;

FIG. 5 is a flowchart of a post-processing method for a multi-task learning model, according to an embodiment of the present disclosure; and

FIG. 6 is a block diagram illustrating a computing system for executing a post-processing method for a multi-task learning model, according to each embodiment of the present disclosure.

### DETAILED DESCRIPTION

Hereinafter, embodiments of the present disclosure are described in detail with reference to the accompanying drawings. In the accompanying drawings, identical or equivalent components are designated by the identical numeral even when they are displayed in different drawings. Further, in describing the embodiment of the present disclosure, where it has been considered that a specific description of well-known configurations, features or functions may obscure the gist of the present disclosure, a detailed description thereof has been omitted.

In the following description of components of embodiments of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by those having ordinary skill in the art to which this disclosure pertains. Such terms as those defined in commonly used dictionaries should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

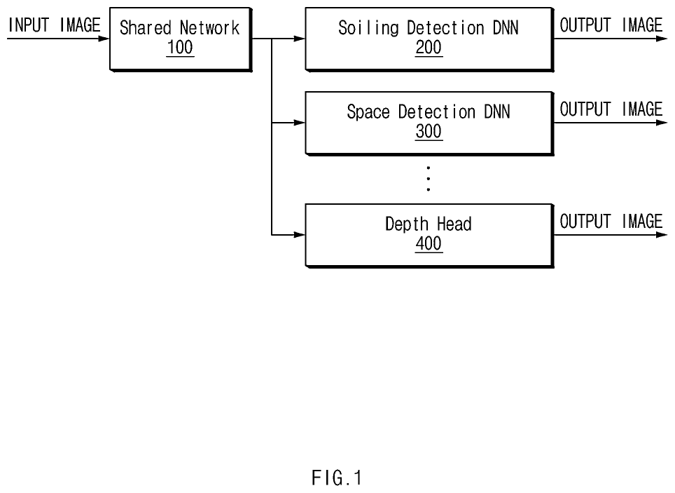

FIG. 1 is a diagram illustrating a multi-task learning model, according to an embodiment of the present disclosure.

As shown in FIG. 1, a multi-task learning model according to an embodiment of the present disclosure may include a shared network 100, a soiling detection deep neural network (DNN) 200, a space detection DNN 300, and a depth head 400.

The shared network 100 may extract common features used for learning by the soiling detection DNN 200, the space detection DNN 300, and the depth head 400. The soiling detection DNN 200, the space detection DNN 300, and the depth head 400 may perform learning to solve their tasks based on the common features extracted by the shared network 100.

The soiling detection DNN 200 may recognize (or predict) an area where a camera lens is contaminated in an image based on the common features extracted by the shared network 100. In embodiments, contamination of the camera lens refers to a state in which dust, water droplets, or mud are attached to the camera lens, for example.

The soiling detection DNN 200 may misrecognize a puddle on the road as dirt or misrecognize a pedestrian as dust when the pedestrian is wearing black clothes. Because misrecognition by the soiling detection DNN 200 may be a factor that degrades the performance of the multi-task learning model, a post-processing process according to an embodiment of the present disclosure may be performed.

The space detection DNN 300 may be a fully trained DNN configured to recognize (or predict) an object region in an image based on the common features extracted by the shared network 100. In embodiments, the object may include a road, a vehicle, a pedestrian, a bicycle, a traffic line, and the like.

The space detection DNN 300 may include a segmentation head and an object detection head. Thus, pixels in an image may be classified into categories and objects represented by each category may be detected.

The space detection DNN 300 may misrecognize an area of an object in an image when contamination occurs in a camera lens. Because misrecognition by the space detection DNN 300 may be a factor that degrades the performance of the multi-task learning model, a post-processing process according to another embodiment of the present disclosure may be performed.

For reference, because the soiling detection DNN 200 and the space detection DNN 300 are mutually exclusive, the ensemble between the entropy of pixels in the image (i.e., the output image) predicted by the soiling detection DNN 200 and the entropy of pixels in the image (i.e., the output image) predicted by the space detection DNN 300 may solve the misrecognition of each other.

In embodiments, multi-task learning (MTL), which is a method of simultaneously learning several tasks by providing a plurality of output layers in one deep neural network, utilizes correlation between tasks in the learning process. Because multiple tasks share one deep neural network, learning efficiency may be increased, and the generalization performance of the deep neural network may be improved by preventing overfitting of hidden layers to one task.

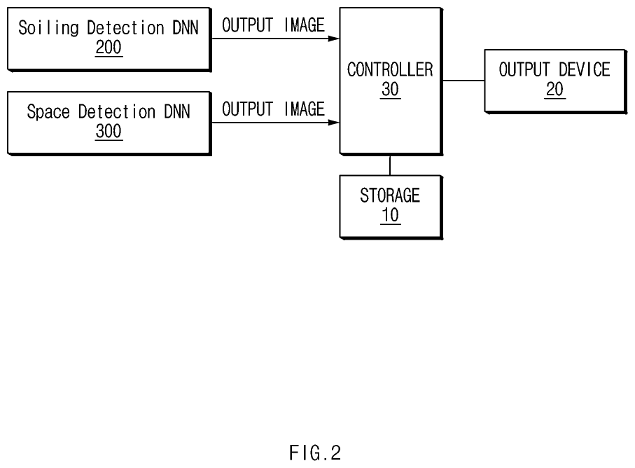

FIG. 2 is a diagram illustrating a configuration of a post-processing apparatus of a multi-task learning model, according to an embodiment of the present disclosure.

As shown in FIG. 2, a post-processing apparatus of a multi-task learning model according to an embodiment of the present disclosure may include storage 10, an output device 20, and a controller 30. Depending on a scheme of implementing post-processing apparatus of a multi-task learning model according to an embodiment of the present disclosure, components may be combined with each other to be implemented as one, or some components may be omitted.

The storage 10 may store various logic, algorithms and programs required in the processes of generating a first entropy image from an output image of a first DNN within a multi-task learning model, generating a second entropy image from an output image of a second DNN, and post-processing the output image of the first DNN or the output image of the second DNN based on the first entropy image and the second entropy image.

The storage 10 may store various logic, algorithms and programs required in the processes of post-processing the output image of the first DNN based on entropy of each pixel in the first entropy image and entropy of each pixel in the second entropy image.

The storage 10 may store various logic, algorithms and programs required in the processes of post-processing the output image of the second DNN based on the entropy of each pixel in the first entropy image and the entropy of each pixel in the second entropy image.

The storage 10 may store various logic, algorithms and programs required in the processes of generating the first entropy image from the output image of the soiling detection DNN 200, generating the second entropy image from the output image of the space detection DNN 300, and post-processing the output image of the soiling detection DNN 200 or the output image of the space detection DNN 300 based on the first entropy image and the second entropy image.

The storage 10 may store various logic, algorithms and programs required in the processes of removing a misrecognized area from the output image of the soiling detection DNN 200 based on the entropy of each pixel in the first entropy image and the entropy of each pixel in the second entropy image.

The storage 10 may store various logic, algorithms and programs required in the processes of removing a misrecognized area from the output image of the space detection DNN 300 based on the entropy of each pixel in the first entropy image and the entropy of each pixel in the second entropy image.

The storage 10 may include at least one type of a storage medium of memories of a flash memory type, a hard disk type, a micro type, a card type (e.g., a secure digital (SD) vehicled or an extreme digital (XD) vehicled), and the like, and a random access memory (RAM), a static RAM, a read-only memory (ROM), a programmable ROM (PROM), an electrically erasable PROM (EEPROM), a magnetic memory (MRAM), a magnetic disk, and an optical disk type memory.

The output device 20 may output one or more of; an image predicted by the soiling detection DNN in the multi-task learning model, an image obtained by removing a misrecognized area from an image predicted by the soiling detection DNN, an image predicted by the space detection DNN in the multi-task learning model, or an image obtained by removing a misrecognized area from an image predicted by the space detection DNN.

The controller 30 may perform overall control such that each component performs its function. The controller 30 may be implemented in the form of hardware or software, or may be implemented in a combination of hardware and software. The controller 30 may be implemented as a microprocessor, but is not limited thereto.

The controller 30 may generate the first entropy image from an output image of the first DNN within the multi-task learning model. The controller 30 may generate the second entropy image from the output image of the second DNN. The controller 30 may post-process the output image of the first DNN or the output image of the second DNN based on the first entropy image and the second entropy image. The controller 30 may post-process the output image of the first DNN based on entropy of each pixel in the first entropy image and entropy of each pixel in the second entropy image. The controller 30 may post-process the output image of the second DNN based on the entropy of each pixel in the first entropy image and the entropy of each pixel in the second entropy image.

The controller 30 may generate the first entropy image from the output image of the soiling detection DNN 200 within the multi-task learning model. The controller 30 may generate the second entropy image from the output image of the space detection DNN 300. The controller 30 may post-process the output image of the soiling detection DNN 200 or the output image of the space detection DNN 300 based on the first entropy image and the second entropy image. The controller 30 may remove a misrecognized area from the output image of the soiling detection DNN 200 based on the entropy of each pixel in the first entropy image and the entropy of each pixel in the second entropy image. The controller 30 may remove a misrecognized area from the output image of the space detection DNN 300 based on the entropy of each pixel in the first entropy image and the entropy of each pixel in the second entropy image.

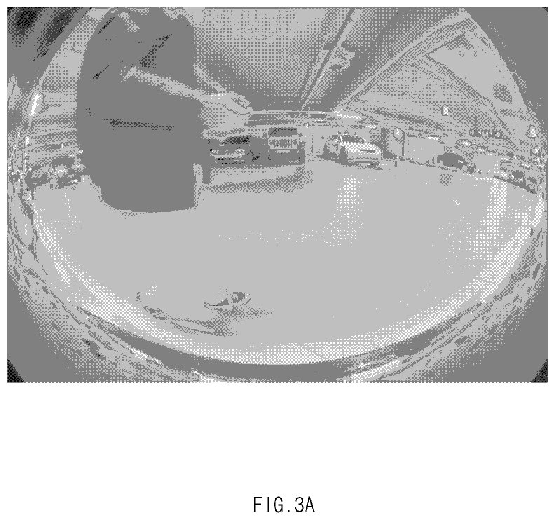

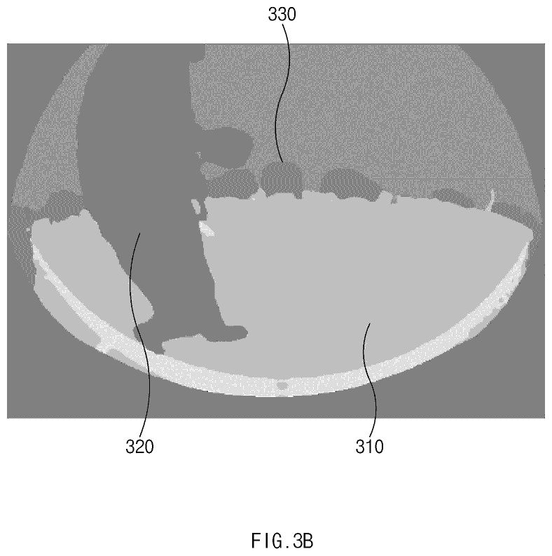

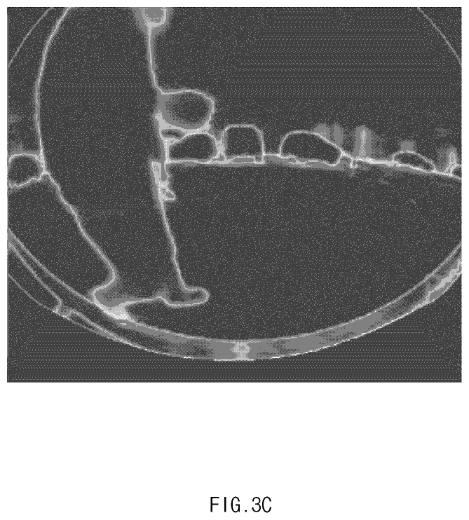

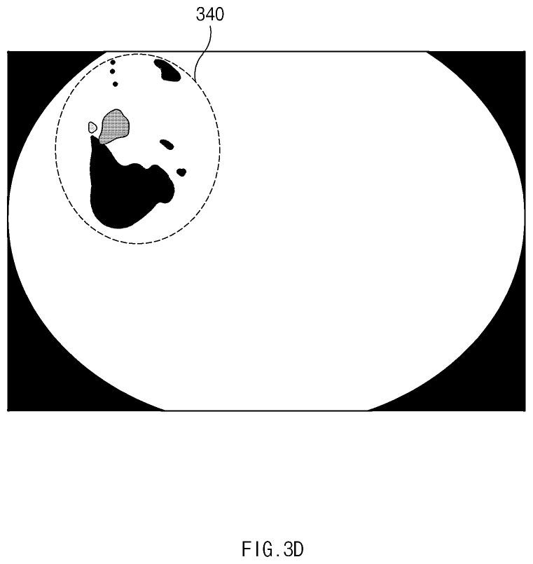

Hereinafter, the operation of the controller 30, according to an embodiment, is described in detail with reference to FIGS. 3A-D.

FIG. 3A is a diagram illustrating a camera image that may be input to a shared network of a multi-task learning model, according to an embodiment of the present disclosure.

As shown in FIG. 3A, a parking lot floor, pedestrians, vehicles, and the like are present in a camera image (or an input image) input to a shared network of a multi-task learning model.

FIG. 3B is a diagram illustrating an output image of a space detection DNN in a multi-task learning model, according to an embodiment of the present disclosure.

The space detection DNN 300 in the multi-task learning model may predict an area of an object (or class) shown in FIG. 3B from a camera image shown in FIG. 3A. The output image shown in FIG. 3B may include a parking lot floor area 310, a pedestrian area 320, and a vehicle area 330 as predicted objects. Each class may be expressed with different shades (or colors), and pixels classified into the same class may be expressed with the same shades (or colors).

For example, when the size (e.g., number of pixels) of the output image of the space detection DNN 300 comprises a height of 100 and a width of 100, the number of classes in the output image of the space detection DNN 300 is 5, and in coordinates (1, 1) in the output image of the space detection DNN 300, the probability value of class 1 is 0.1, the probability value of class 2 is 0.1, the probability value of class 3 is 0, the probability value of class 4 is 0, and the probability value of class 5 is 0.8, the coordinates (1, 1) may be recognized as class 5.

The output image of the space detection DNN 300 may include class information for each pixel. For example, the output image of the space detection DNN 300 may include, as information about coordinates (1, 1), the probability value of class 1 of 0.1, the probability value of class 2 of 0.1, the probability value of class 3 of 0, the probability value of class 4 of 0, and the probability value of class 5 of 0.8.

FIG. 3C is a diagram illustrating entropy image generated by a controller included in a post-processing apparatus of a multi-task learning model based on an output image of a space detection DNN, according to an embodiment of the present disclosure.

As shown in FIG. 3C, the controller 30 may generate an entropy image from an output image of the space detection DNN 300. The controller 30 may determine the entropy (E^{(h, w)}) of each pixel in the output image of the space detection DNN 300 based on Equation 1.

$${E}^{( h , w )} = {\sum }_{c = 1}^{C} {p}^{( h , w )} ( c ) log ( {p}^{( h , w )} ( c ) ) \qquad Equation 1$$

In Equation 1, h is the height pixel coordinates of the output image of the space detection DNN 300, w is the width pixel coordinates of the output image of the space detection DNN 300, and c is the number of classes included in the output image of the space detection DNN 300. In addition, in Equation 1, p is a probability value, and p^{(h, w)} is the probability value of the (h, w)-th pixel.

The controller 30 may determine the entropy of each pixel in the output image of the space detection DNN 300 based on Equation 1, and determine the entropy of each class based on the entropy of each pixel. For example, when all pixels are A, B, C, D, E, the entropy of A is 0.2, the entropy of B is 0.6, the entropy of C is 0.4, the entropy of D is 0.1, the entropy of E is 0.5, and pixels A, B and C constitute a first class, the controller 30 may determine the average (0.4) of the entropy of A, the entropy of B and the entropy of C as the entropy of the first class. As another example, the controller 30 may determine the entropy of the first class only with entropy exceeding a threshold value (e.g., 0.3) among the entropy of A, the entropy of B and the entropy of C. In this case, the entropy of the first class is 0.5.

The controller 30 may determine the entropy (E̅ₖ̅) of each class based on Equation 2.

$${E}_{k} {{\sum }^{H}}_{h = 1} {{\sum }^{W}}_{w = 1} {{\sum }^{C}}_{c = 1} {p}^{( h , w )} ( c ) log ( {p}^{( h , w )} ( c ) ) if {argmax}_{c} ( {p}^{( h , w )} ( c ) ) = k \qquad Equation 2$$

$$\overline{{E}_{k}} = \frac{{E}_{k}}{\# {argmax}_{c} ( {p}^{( h , w )} ( c ) ) = k}$$

In Equation 2, Eₖ is the sum of the entropy of pixels constituting class k, h is the height pixel coordinates of the output image of the deep learning model, w is the width pixel coordinates of the output image of the deep learning model, and c is the number of classes included in the output image of the deep learning model. In addition, in Equation 2, p is a probability value, and p^{(h, w)} is a probability value of the (h, w)-th pixel.

FIG. 3D is a diagram illustrating an output image of a soiling detection DNN in a multi-task learning model, according to an embodiment of the present disclosure.

As shown in FIG. 3D, the soiling detection DNN 200 in the multi-task learning model may misrecognize the black clothes area of a pedestrian in the camera image shown in FIG. 3A as an contaminated area 340 in the camera lens.

The controller 30 may determine the entropy (E^{(h, w)}) of each pixel in the output image of the soiling detection DNN 200 based on Equation 3.

$${E}^{( h , W )} = {\sum }_{c = 1}^{C} {p}^{( h , w )} ( c ) log ( {p}^{( h , w )} ( c ) ) \qquad Equation 3$$

In Equation 3, h is the height pixel coordinates of the output image of the soiling detection DNN 200, w is the width pixel coordinates of the output image of the soiling detection DNN 200, and c is the number of classes included in the output image of the soiling detection DNN 200. In addition, in Equation 3, p is a probability value, and p^{(h, w)} is a probability value of the (h, w)-th pixel.

The controller 30 may remove the misrecognized area in the output image of the soiling detection DNN 200 based on the entropy of each pixel in the output image of the soiling detection DNN 200 and the entropy of each pixel in the output image of the space detection DNN 300.

For example, when the entropy of a pixel derived from the output image of the soiling detection DNN 200 does not exceed a threshold (i.e., the prediction reliability is high), and the entropy of a pixel derived from the output image of the space detection DNN 300 exceeds a threshold (i.e., the prediction reliability is low), the controller 30 may determine the pixel in the output image of the soiling detection DNN 200 as a contaminated area. In this case, the two pixels have the same location coordinates under the condition for determining the contaminated area of a pixel.

As another example, when the entropy of the pixel derived from the output image of the soiling detection DNN 200 exceeds the threshold (i.e., the prediction reliability is low), and the entropy of a pixel derived from the output image of the space detection DNN 300 does not exceed the threshold (i.e., the prediction reliability is high), the controller 30 may determine the pixel in the output image of the soiling detection DNN 200 as a normal area, and may remove the pixel from the misrecognized area 340 in the output image of the soiling detection DNN 200.

Generally, because entropy indicates uncertainty, entropy exceeding a threshold means that the uncertainty is high. In addition, because the soiling detection DNN 200 and the space detection DNN 300 are mutually exclusive, the case where the entropy derived from the output image of the soiling detection DNN 200 and the entropy derived from the output image of the space detection DNN 300 are both low or high does not occur.

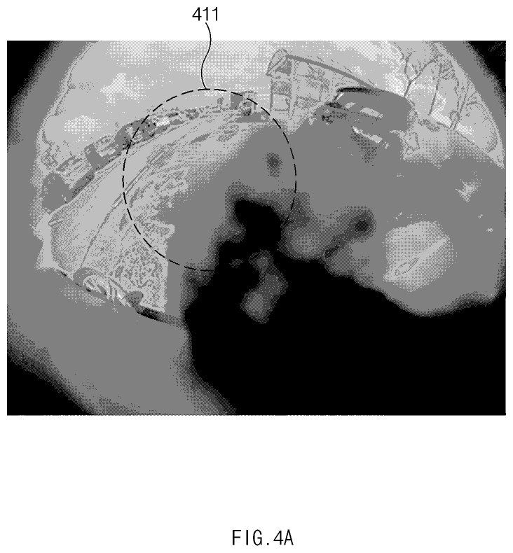

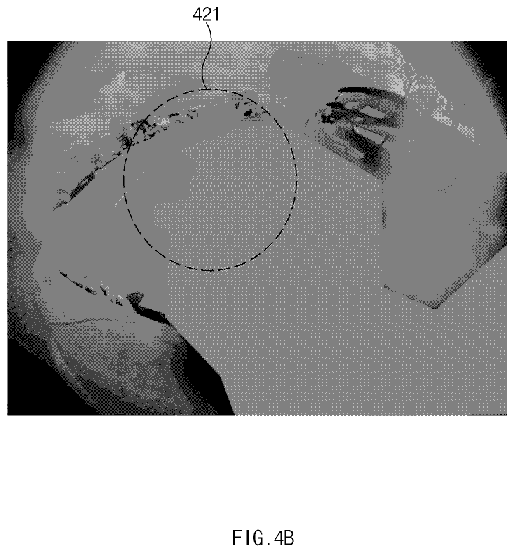

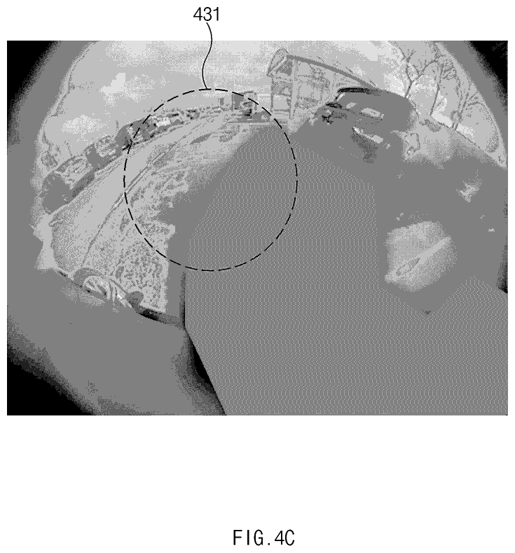

FIGS. 4A-C are diagrams illustrating performance of a post-processing apparatus of a multi-task learning model, according to an embodiment of the present disclosure.

FIG. 4A illustrates an input image of a multi-task learning model. FIG. 4B illustrates an output image of the soiling detection DNN 200. FIG. 4C illustrates an image obtained by post-processing of an output image of the soiling detection DNN 200 by a post-processing apparatus, according to an embodiment of the present disclosure.

As shown in FIG. 4A, there is a puddle on the road in the input image an area 411.

However, as shown in FIG. 4B, the soiling detection DNN 200 misrecognizes the puddle area 411 as a dust area 421.

Accordingly, as shown in FIG. 4C, a post-processing apparatus according to an embodiment of the present disclosure removes the puddle area misrecognized by the soiling detection DNN 200 from the dust area, resulting in an area 431.

The post-processing apparatus according to an embodiment of the present disclosure may thus improve the performance of the multi-task learning model by removing the misrecognized area caused by the soiling detection DNN 200.

In embodiments described above, the soiling detection DNN may be replaced with a vision fail safety (VFS) DNN.

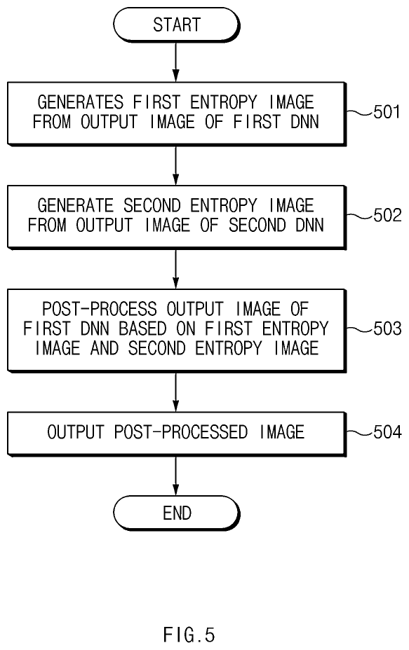

FIG. 5 is a flowchart of a post-processing method for a multi-task learning model, according to an embodiment of the present disclosure.

In an operation 501, the controller 30 may generate a first entropy image from an output image of a first DNN within the multi-task learning model.

In and operation 502, the controller 30 may generate a second entropy image from an output image of a second DNN in the multi-task learning model.

In an operation 503, the controller 30 may post-process the output image of the first DNN based on the first entropy image and the second entropy image.

In an operation 504, the output device 20 may output the post-processed image.

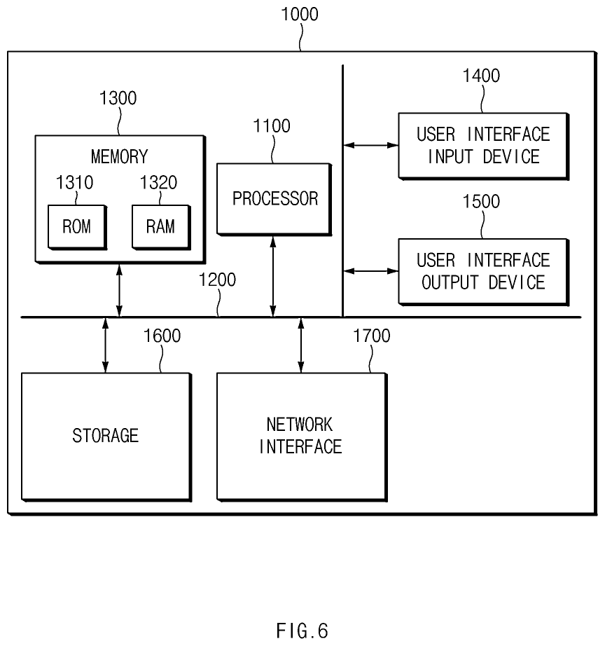

FIG. 6 is a block diagram illustrating a computing system for executing a post-processing method for a multi-task learning model, according to embodiments of the present disclosure.

Referring to FIG. 6, a post-processing method for a multi-task learning model according to an embodiment of the present disclosure may be implemented in a computing system 1000. The computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

The processes of the method or algorithm described in relation to the embodiments of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, solid state drive (SSD), a detachable disk, or a CD-ROM. The storage medium may be coupled to the processor 1100, and the processor 1100 may read information from the storage medium and may write information to the storage medium. In another embodiment, the storage medium may be integrated with the processor 1100. The processor 1100 and the storage medium may reside in an application specific integrated circuit (ASIC). The ASIC may reside in a user terminal. In another embodiment, the processor 1100 and the storage medium may reside in the user terminal as individual components.

According to embodiments of the present disclosure, a post-processing apparatus for a multi-task learning model and a method thereof may generate a first entropy image from an output image of a first DNN in the multi-task learning model, may generate a second entropy image from an output image of a second DNN, and may post-process the output image of the first the output image of the second DNN based on the first entropy image and the second entropy image, thereby improving the performance of the multi-task learning model.

In addition, various effects that are directly or indirectly understood from the present disclosure may be provided.

Although embodiments of the present disclosure have been described for illustrative purposes, those having ordinary skill in the art should appreciate that various modifications, additions and substitutions are possible without departing from the scope and spirit of the disclosure. Therefore, the embodiments described in the present disclosure are provided for the sake of illustration. It should be understood that such embodiments are not intended to limit the scope of the technical concepts of the present disclosure. The protection scope of the present disclosure should be understood by the claims below, and all the technical concepts within the equivalent scopes should be interpreted to be within the scope of the present disclosure.

What is claimed is:

1. A post-processing apparatus for a multi-task learning model, the post-processing apparatus comprising:
a storage medium configured to store the multi-task learning model; and
a controller configured to:
generate a first entropy image from an output image of a first deep neural network (DNN) within the multi-task learning model,
generate a second entropy image from an output image of a second DNN in the multi-task learning model, and
post-process the output image of the first DNN based on the first entropy image and the second entropy image.

2. The post-processing apparatus of claim 1, wherein the controller is configured to post-process the output image of the first DNN based on entropy of each pixel in the first entropy image and entropy of each pixel in the second entropy image.

3. The post-processing apparatus of claim 1, wherein the first DNN includes a soiling detection DNN configured to recognize an area in which a camera lens is contaminated in an input image.

4. The post-processing apparatus of claim 3, wherein the second DNN includes a space detection DNN configured to classify pixels in the input image by category and detect an object corresponding to each category.

5. The post-processing apparatus of claim 4, wherein the controller is configured to:
generate the first entropy image from the output image of the soiling detection DNN,
generate the second entropy image from the output image of the space detection DNN, and
post-process the output image of the soiling detection DNN based on the first entropy image and the second entropy image.

6. The post-processing apparatus of claim 5, wherein the controller is configured to remove a misrecognized area from the output image of the soiling detection DNN based on entropy of each pixel in the first entropy image and entropy of each pixel in the second entropy image.

7. The post-processing apparatus of claim 6, wherein the controller is configured to determine a first as a contaminated area in the output image of the soiling detection DNN when entropy of the first pixel in the first entropy image does not exceed a threshold and entropy of the first pixel in the second entropy image exceeds the threshold.

8. The post-processing apparatus of claim 6, wherein the controller is configured to determine a first pixel as a normal area in the output image of the soiling detection DNN and remove the first pixel from a misrecognized area in the output image of the soiling detection DNN when entropy of the first pixel in the first entropy image exceeds a threshold and entropy of a first pixel in the second entropy image does not exceed the threshold.

9. A post-processing method for a multi-task learning model, the post-processing method comprising:
generating, by a controller, a first entropy image from an output image of a first deep neural network (DNN) within the multi-task learning model;
generating, by the controller, a second entropy image from an output image of a second DNN in the multi-task learning model; and
post-processing, by the controller, the output image of the first DNN based on the first entropy image and the second entropy image.

10. The post-processing method of claim 9, wherein post-processing the output image of the first DNN includes post-processing, by the controller, the output image of the first DNN based on entropy of each pixel in the first entropy image and entropy of each pixel in the second entropy image.

11. The post-processing method of claim 9, wherein the first DNN includes a soiling detection DNN that recognizes an area in which a camera lens is contaminated in an input image.

12. The post-processing method of claim 11, wherein the second DNN includes a space detection DNN that classifies pixels in the input image by category and detects an object corresponding to each category.

13. A post-processing method for a multi-task learning model, the post-processing method comprising:
generating, by a controller, a first entropy image from an output image of a soiling detection DNN;
generating, by the controller, a second entropy image from an output image of a space detection DNN; and
post-processing, by the controller, the output image of the soiling detection DNN based on the first entropy image and the second entropy image.

14. The post-processing method of claim 13, wherein post-processing the output image of the soiling detection DNN includes removing, by the controller, a misrecognized area from the output image of the soiling detection DNN based on entropy of each pixel in the first entropy image and entropy of each pixel in the second entropy image.

15. The post-processing method of claim 14, wherein removing the misrecognized area includes determining, by the controller, a first pixel as a contaminated area in the output image of the soiling detection DNN when entropy of the first pixel in the first entropy image does not exceed a threshold and entropy of the first pixel in the second entropy image exceeds the threshold.

16. The post-processing method of claim 14, wherein removing the misrecognized area includes:
determining, by the controller, a first pixel as a normal area in the output image of the soiling detection DNN when entropy of the first pixel in the first entropy image exceeds a threshold and entropy of a first pixel in the second entropy image does not exceed the threshold; and
removing, by the controller, the first pixel from a misrecognized area in the output image of the soiling detection DNN.
